(19) United States
(12) Patent Application Publication
(10) Pub. No.: US 2019/0097211 A1
(43) Pub. Date: Mar. 28, 2019

(54) DENSE ELECTRODE FOR SOLID STATE BATTERY

(71) Applicant: Wildcat Discovery Technologies, Inc., San Diego, CA (US)

(72) Inventors: Cory O'Neill, San Diego, CA (US); Alex Freigang, San Diego, CA (US); Bin Li, San Diego, CA (US); Kyler Carroll, Cardiff, CA (US)

(21) Appl. No.: 15/712,858

(22) Filed: Sep. 22, 2017

(51) Int. Cl. H01M 4/1391; H01M 4/04; H01M 10/0562; H01M 10/0525; H01M 4/62

(52) U.S. Cl. CPC H01M 4/1391; H01M 4/0471; H01M 10/0562; H01M 2004/029; H01M 4/621; H01M 4/628; H01M 10/0525

(57) ABSTRACT

A method for producing a cathode membrane for use in a lithium ion battery using milling and sintering. The cathode membrane is comparatively dense. The cathode membrane can be formed by a composition of active materials and inorganic lithium ion conductors. Conductive additives can be included in the cathode composition. A conducting coating can be applied to a surface of the cathode membrane.

### BACKGROUND OF THE INVENTION

The present invention is in the field of battery technology and, more particularly, in the area of high-energy materials for use in electrodes in electrochemical cells having solid-state electrolytes.

Producers of modern lithium ion electrochemical cells are concerned with the safety of such cells as well as the electrochemical performance of such cells. In most lithium ion cells, the electrolyte is composed of a liquid solvent and an ion conducting salt. These liquid electrolytes are often flammable, and thus present safety challenges for lithium ion batteries. Most current lithium ion batteries use a graphite-based anode. However, use of a lithium metal anode greatly improves the energy density of the cell compared to graphite. Lithium metal anodes present safety challenges, as the lithium tends to deposit as dendrites during plating. The dendrites can penetrate the battery separator, resulting in short circuiting of the battery. This, in turn, can lead to volatilization of the liquid electrolyte due to increased temperature. In worst cases, the electrolyte can ignite resulting in a battery fire. Solid electrolytes can help to prevent dendrite growth and cell shorting, and therefore enable the use of high energy density lithium metal anodes. Thus, the formation of dendrites can lead to short circuiting of the battery, which in turn leads to faster discharge, lower capacity, and in some cases combustion of the electrolyte.

Slowing or preventing dendrite formation would enable battery manufacturers to safely use anodes that are almost entirely pure lithium, which would result in an increase of energy density for the electrochemical cell by replacing the lower energy density materials in the anodes. This increase would be applicable over a wide range of cathode compositions.

Lithium transport must occur in the cathode in functional lithium ion electrochemical cells. In cells having liquid electrolytes, pores created in the cathode are filled with liquid electrolyte material, which serves as a reservoir of lithium ions. A network of pores through the cathode allows bulk mass transport of lithium-ion-bearing electrolyte as the cell is charged or discharged. The pores in the cathode will typically take up 20-30% of the cathode by volume to facilitate conduction. However, in an all-solid cell, the solid electrolyte cannot flow into the empty pores and, therefore, lithium transport through the cathode is inhibited. Thus, a dense, ionically conducting cathode membrane is desired.

Ideally, a cathode for use with a solid electrolyte would contain predominantly electroactive material, as well as be dense, ionically conductive, and electronically conductive. Electrochemically active layered oxide materials such as lithium cobalt oxide (LCO) or lithium nickel manganese cobalt oxide (NMC) can be sintered using high temperatures such that the individual cathode particles are fused, which increases the density of the cathode. This dense and fused structure allows lithium ions and electrons to move from particle to particle through the structure. However, the temperatures at which these materials sinter are high enough to degrade the electrochemical properties of the material. Thus, a method that can both lower the sintering temperature and enhance the lithium ion conductivity of the sintered membrane is desirable.

Conventional cathode films used with liquid electrolytes contain conductive carbon additives to enhance electronic conductivity. These types of additives are not thermally stable at sintering temperatures in air. Thus, replacements for conductive carbon additives that are thermally stable in sintering temperatures in air are desired.

Conventional cathode films used with liquid electrolytes also are strongly adhered to metal film current collectors using polymeric binders. This ensures good electronic conductivity between the cathode film and the current collector. However, no such adhesion is obtained between freestanding sintered membranes and the current collector. Thus, a method for ensuring good electronic conductivity between freestanding sintered membranes and the current collector is desired.

The disclosure herein presents cathode active material formation methods and compositions that are designed for use in solid-state electrochemical cells.

### BRIEF SUMMARY OF THE INVENTION

Embodiments of the invention include a method for producing a cathode membrane for use in a lithium ion battery. Embodiments of the invention include a dense cathode and methods of preparation for such a cathode. The cathode can, in some embodiments, be formed by a composition of active materials and inorganic lithium ion conductors, which can also serve as sintering aids. In some embodiments, inorganic electronic conducting additives are included in the cathode composition. Some embodiments for the preparation of such a cathode are also disclosed herein, and in certain embodiments this inorganic composite takes the form of a film or membrane.

Some of the disclosed methods of preparation herein allow an inorganic membrane to be created with a controllable thickness, ranging from approximately 10 microns to 300 microns, though thicknesses outside of this range should not be excluded from this disclosure. Some embodiments of the cathode material presented herein utilize lithium nickel manganese cobalt oxide (NMC) materials as active materials, however this disclosure should not be construed to limit the cathode to such chemistries.

Some embodiments of the invention have improved density and volumetric capacities relative to conventional electrodes. Embodiments of the invention include batteries having an electrode formed from any of the active materials disclosed herein. Embodiments of the invention include processes for making the active materials disclosed above as described herein.

Other embodiments of the invention include conductive coatings applied to the sintered membrane, such as gold coatings or conductive carbon coatings.

### BRIEF DESCRIPTION OF SEVERAL VIEWS OF THE DRAWINGS

FIG. 1 is a scanning electron micrograph of a sintered cathode that uses a composition of LiF:LiBO₂ as a sintering aid and ion conductor.

FIG. 2 illustrates the results of a test of first cycle capacity for a sintered NMC cathode with various ratios of LiF:LiBO₂ and various weight percentages of LiF:LiBO₂ versus NMC.

FIG. 3 illustrates the results of a test of capacity versus cycle number for a sintered NMC cathode having various ion conducting components.

FIG. 4A illustrates sintered electrode density versus active material content (in this case NMC) of a cathode.

FIG. 4B illustrates volumetric capacity of a sintered electrode versus active material content (in this case NMC) of a cathode.

FIG. 5 illustrates the results of a capacity versus cycle number test for sintered NMC cathodes containing inorganic electron-conducting additives.

FIG. 6 illustrates the results of a capacity versus cycle number test for sintered NMC cathodes containing inorganic electron-conducting additives.

FIG. 7 shows three scanning electron micrographs of sintered electrodes in which the sintering time has been varied.

FIG. 8 shows three scanning electron micrographs of sintered electrodes in which the milling time has been varied.

FIG. 9 illustrates the results of electrochemical testing of a sintered NMC cathode, showing the voltage versus capacity performance at cycle one, cycle three, and cycle five in a solid-state battery.

FIG. 10 illustrates the results of tests of the discharge capacity at various cycle numbers for a sintered NMC cathode in a solid-state battery.

FIG. 11A illustrates the results of electrochemical testing of a sintered NMC cathode, showing the voltage versus capacity at cycle one for sintered cathodes with and without conductive coatings in contact with the current collector.

FIG. 11B illustrates the results of electrochemical testing of a sintered NMC cathode, showing the capacity versus C-rate for sintered cathodes with and without conductive coatings in contact with the current collector.

### DETAILED DESCRIPTION OF THE INVENTION

The following definitions apply to some of the aspects described with respect to some embodiments of the invention. These definitions may likewise be expanded upon herein. Each term is further explained and exemplified throughout the description, figures, and examples. Any interpretation of the terms in this description should take into account the full description, figures, and examples presented herein.

The singular terms “a,” “an,” and “the” include the plural unless the context clearly dictates otherwise. Thus, for example, reference to an object can include multiple objects unless the context clearly dictates otherwise.

The terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

The term “specific capacity” refers to the amount (e.g., total or maximum amount) of electrons or lithium ions a material is able to hold (or discharge) per unit mass and can be expressed in units of mAh/g. In certain aspects and embodiments, specific capacity can be measured in a constant current discharge (or charge) analysis, which includes discharge (or charge) at a defined rate over a defined voltage range against a defined counter electrode. For example, specific capacity can be measured upon discharge at a rate of about 0.05 C (e.g., about 7 mA/g) from 4.95 V to 3.0 V versus a Li/Li+ counter electrode. Other discharge rates and other voltage ranges also can be used, such as a rate of about 0.1 C (e.g., about 14 mA/g), or about 0.5 C (e.g., about 70 mA/g), or about 1.0 C (e.g., about 140 mA/g).

A rate “C” refers to either (depending on context) the discharge current as a fraction or multiple relative to a “1 C” current value under which a battery (in a substantially fully charged state) would substantially fully discharge in one hour, or the charge current as a fraction or multiple relative to a “1 C” current value under which the battery (in a substantially fully discharged state) would substantially fully charge in one hour.

The term “NMC” refers generally to cathode materials containing LiNiₓMn_{y}Co_{z}O_{w} where 0≤x<1; 0≤y<1; 0≤y≤1; and 1.8≤w≤2.2, and includes, but is not limited to, cathode materials containing LiNi_{0.33}Mn_{0.33}Co_{0.33}O₂, LiNi_{0.5}Mn_{0.3}Co_{0.2}O₂, LiNi_{0.6}Mn_{0.2}Co_{0.2}O₂, and LiNi_{0.8}Mn_{0.1}Co_{0.1}O₂.

To the extent certain battery characteristics can vary with temperature, such characteristics are specified at 30 degrees Celsius, unless the context clearly dictates otherwise.

Ranges presented herein are inclusive of their endpoints. Thus, for example, the range 1 to 3 includes the values 1 and 3 as well as the intermediate values.

Embodiments of the present invention concern composite cathode materials and their formation for use in electrochemical cells having solid-state electrolytes. In some preferred embodiments, these cathode materials incorporate at least one inorganic lithium ion conductor.

In some embodiments, improved cyclic capacity of electrochemical cells is seen through the addition of materials such as those described in this specification.

Embodiments of the present invention provide novel materials for use as cathode membranes in an electrochemical cell. The materials of the present invention address the challenges described above for existing cathode active materials. Specifically, at least some of the embodiments disclosed herein use a new method of making cathodes for lithium ion batteries.

In at least some embodiments, additives are also present in addition to ionic conductors. Some of these conductors and/or additives can be sintering aids to assist in the production of the cathode membranes disclosed herein. In some embodiments, no sintering aids are present, and in some embodiments electronic conductors and/or additives are present, but these materials do not act as sintering aids. In some embodiments, sintering aids increase the overall density of the active material.

As discussed further below, in some embodiments the process to make the cathode involves a milling process. Milling methods should be read to include but not be limited to methods of ball milling and can include high energy and low energy ball milling.

In some of the production embodiments and examples disclosed herein, lithium and/or electron conductors are added in their final forms, while in other embodiments precursors of the conductor's final form are added to the electrode. In such embodiments, the final conductor will be formed under processing conditions by interactions among or between the precursors and other materials or the precursors and other precursors. Composites formed herein ideally (though not exclusively) produce freestanding electrodes that can be controlled for properties such as thickness and flatness.

In at least some embodiments, a cathode material formation process consists of a milling step, a slurrying step, a tape casting step, a drying step, and at least one annealing step. In some embodiments, a slurrying step consists of mixing the milled material with solvents such as N-methyl-2-pyrrolidone (NMP), high boiling point solvents such as benzyl butyl phthalate (BBP) or tetraethylene glycol (TEG), and binders such as polyvinyl butyral (PB) or polyacrylic acid (PA). In some embodiments, a slurrying step results in a flatter and denser membrane than formation methods lacking a slurrying step, and in at least some embodiments the liquids are removed or decomposed during a sintering process. Sometimes, this sintering process comprises the above drying and annealing steps.

In order to aid electronic conductivity in a sintered membrane, inorganic electron-conducting additives may be used which are stable at elevated temperatures in air. ReO₂, IrO₂, and TiN are examples of such inorganic electron conducting-additives. In certain embodiments, a electronically conductive additive is added to the precursor mixture prior to milling in an amount of no less than 0.05% by weight, 0.10% by weight, 0.15% by weight, 0.20% by weight, 0.25% by weight, 0.30% by weight, 0.35% by weight, 0.40% by weight, 0.45% by weight, 0.5% by weight, 0.6% by weight, 0.7% by weight, 0.8% by weight, 0.9% by weight, no less than 1.0% by weight, no less than 1.5% by weight, no less than 2.0% by weight, no less than 2.5% by weight, no less than 3.0% by weight, no less than 3.5% by weight, no less than 4.0% by weight, no less than 4.5% by weight, no less than 5.0% by weight, no less than 5.5% by weight, no less than 6.0% by weight, no less than 6.5% by weight, no less than 7.0% by weight, no less than 7.5% by weight, no less than 8.0% by weight, no less than 8.5% by weight, no less than 9.0% by weight, no less than 9.5% by weight, no less than 10.0% by weight, no less than 10.5% by weight, no less than 11.0% by weight, no less than 11.5% by weight, no less than 12.0% by weight, no less than 12.5% by weight, no less than 13.0% by weight, no less than 13.5% by weight, no less than 14.0% by weight, no less than 14.5% by weight, or no less than 15.0% by weight of the total weight of the mixture.

In certain embodiments, powder resulting from the milling process and/or a slurry resulting from this powder and/or a material formed as a product of this slurry is sintered and/or annealed at a temperature greater than about 450 degrees C., greater than about 460 degrees C., greater than about 470 degrees C., greater than about 480 degrees C., greater than about 490 degrees C., greater than about 500 degrees C., greater than about 510 degrees C., greater than about 520 degrees C., greater than about 530 degrees C., or greater than about 540 degrees C., 550 degrees C., greater than about 560 degrees C., greater than about 570 degrees C., greater than about 580 degrees C., greater than about 590 degrees C., greater than about 600 degrees C., greater than about 610 degrees C., greater than about 620 degrees C., greater than about 630 degrees C., or greater than about 640 degrees C., 650 degrees C., greater than about 660 degrees C., greater than about 670 degrees C., greater than about 680 degrees C., greater than about 690 degrees C., greater than about 700 degrees C., greater than about 710 degrees C., greater than about 720 degrees C., greater than about 730 degrees C., or greater than about 740 degrees C., greater than about 750 degrees C., greater than about 760 degrees C., greater than about 770 degrees C., greater than about 780 degrees C., greater than about 790 degrees C., greater than about 800 degrees C., greater than about 810 degrees C., greater than about 820 degrees C., greater than about 830 degrees C., or greater than about 840 degrees C., greater than about 850 degrees C., greater than about 860 degrees C., greater than about 870 degrees C., greater than about 880 degrees C., greater than about 890 degrees C., greater than about 900 degrees C., greater than about 910 degrees C., greater than about 920 degrees C., greater than about 930 degrees C., or greater than about 940 degrees C., greater than about 950 degrees C., greater than about 960 degrees C., greater than about 970 degrees C., greater than about 980 degrees C., greater than about 990 degrees C., greater than about 1000 degrees C., greater than about 1010 degrees C., greater than about 1020 degrees C., greater than about 1030 degrees C., or greater than about 1040 degrees C., greater than about 1050 degrees C., greater than about 1060 degrees C., greater than about 1070 degrees C., greater than about 1080 degrees C., greater than about 1090 degrees C., greater than about 1100 degrees C., greater than about 1110 degrees C., greater than about 1120 degrees C., greater than about 1130 degrees C., or greater than about 1140 degrees C., greater than about 1150 degrees C., greater than about 1160 degrees C., greater than about 1170 degrees C., greater than about 1180 degrees C., greater than about 1190 degrees C., greater than about 1200 degrees C., greater than about 1210 degrees C., greater than about 1220 degrees C., greater than about 1230 degrees C., or greater than about 1240 degrees C., or greater than about 1250 degrees C.

In certain embodiments, the annealing is performed for a time no less than about 1 minute, no less than about 2 minutes, no less than about 3 minutes, no less than about 4 minutes, no less than about 5 minutes, no less than about 10 minutes, no less than about 0.5 hour, no less than about 1.0 hour, no less than about 1.5 hours, no less than about 2.0 hours, no less than about 2.5 hours, no less than about 3.0 hours, no less than about 3.5 hours, or no less than about 4.0 hours.

In certain embodiments, the sintering is performed for a time no less than about 0.1 hour, no less than about 0.5 hour, no less than about 1.0 hour, no less than about 1.5 hours, no less than about 2.0 hours, no less than about 2.5 hours, no less than about 3.0 hours, no less than about 3.5 hours, no less than about 4.0 hours, no less than about 4.5 hours, no less than about 5.0 hours, no less than about 5.5 hours, no less than about 6.0 hours, no less than about 6.5 hours, no less than about 7.0 hours, no less than about 7.5 hours, no less than about 8.0 hours, no less than about 8.5 hours, no less than about 9.0 hours, no less than about 9.5 hours, no less than about 10.0 hours, no less than about 10.5 hours, no less than about 11.0 hours, no less than about 11.5 hours, or no less than about 12.0 hours.

Specific examples of ion conducting sintering aides include LiF:LiBO₂ as a composite and Li₃PO₄. Other lithium ion conductors with low melting points can also be used. In one embodiment where in the conductor is a LiF:LiBO₂, this composite can be pre-milled or directly incorporated into the cathode active material as the solid state electrolyte material.

In at least some embodiments of the cathode material, production methods involving sintering show increased performance relative to control materials and relative to un-sintered materials. Specifically, using Li₂O in combination with LiBO₂ as precursors, which are expected to form Li₃BO₃ in situ during a sintering process, showed improved performance as compared to the use of Li₃BO₃ added ex situ prior to sintering. Similar advantages were shown by using LiF with LiBO₂ as precursors, relative to the use of Li₃BO₃.

In some embodiments, added precursors can react directly with an NMC cathode material during sintering, and in some embodiments precursors can react with phosphate-based cathode materials during sintering. In some embodiments, phosphate-based cathode materials are used. Some phosphate based cathode materials are selected to provide stability at desired sintering temperatures. Some examples of sintering processes are provided later in this disclosure. In some embodiments, added precursors more effectively interface with cathode material surfaces when sintered.

The sintering aids used herein are inorganic lithium ion conductors. These materials undergo sintering with the electrochemically active material to yield fused particles in a cathode membrane. In some embodiments, the sintering aids retain their chemical composition throughout the sintering process. In other embodiments, the sintering aids have a different chemical composition at the end of the sintering process due to decomposition and/or reaction with the electrochemically active material and/or the gasses present during the sintering process. In all cases, the final composition of the sintering aid in the cathode membrane is referred to as a sintering product. Thus, the sintering product can be unreacted sintering aid, reacted sintering aid (in which the sintering aid has reacted with other components in the cathode mixture during sintering), decomposed sintering aid, and combinations thereof.

In some embodiments, a sintered cathode material can comprise an additive, and in some embodiments a sintered cathode material can comprise a plurality of additives. These embodiments often provide improved electronic conductivity and/or improved ionic conductivity of a sintered cathode. In certain embodiments, a cathode consisting primarily of NMC material is sintered with LiF:LiBO₂, and inorganic materials are added before or during the sintering process. Some inorganic materials are known for having increased innate conductivity of electrons relative to other known materials in the art. In other embodiments, compounds having high electronic conductivity, such as ReO₂ and IrO₂ can be added. In certain embodiments, IrO₂ demonstrates improved capacity in a LiF:LiBO₂/NMC cathode system. In other embodiments, improved capacity can be accomplished with the addition of TiN. In some embodiments, a cathode system includes Li₂O:LiBO₂ in addition to an NMC, and in a preferred embodiment IrO₂ is added to this system during sintering.

Still further, the cathode active material is not limited to NMC materials. Other layered oxide active materials, and in particular those with dopants, such as LiNi_{0.85}Al_{0.05}Co_{0.1}O₂ (NCA), can be used to take advantage of the dense cathode fabrication processes disclosed herein. As discussed above, layered oxide materials can lose electrochemical activity when treated at sintering temperatures. Layered oxides are generally understood to be layered structures of metal oxide materials having the general formula LiMO₂, where M is one or more metal and in particular at least one transition metal.

Without detracting from the general aspects of the method disclosed herein, certain specific aspects of the method can show a particular influence on the resulting properties of the dense cathode. The milling process can be used to ensure thorough mixing of the cathode active material, the ion conducting sintering agent, and the electronic conductor. The milling conditions that produce desirable results will vary with the physical properties of the starting materials and the milling equipment. Also, the sintering conditions can be selected to produce desirable results in the sintered cathode material.

A general method for producing dense cathodes as disclosed herein includes: 1) preparing a stock solution of solvent (e.g., NMP), high boiling point solvent (e.g, BBP or TEG) and binder (e.g., PB or PA) disclosed herein, which can be stirred overnight; 2) milling the cathode active material and additive materials as disclosed herein; 3) briefly mixing the stock solution and milled cathode materials; 4) casting the mixture to form a film of a desired thickness, such as in the range of about 200 microns to about 300 microns, using a method such as a doctor blade; 5) the cast film is then dried at a comparatively low temperature (such as about 150 degrees Celsius) and cut and calendered; 6) the film is then sintered as disclosed herein to form a membrane; and 7) a final drying step at a comparatively low temperature (such as about 150 degrees Celsius) can be performed prior to battery assembly. In some embodiments, a conducting coating can be applied to one or more surfaces of the membrane.

The sintering step can include several sub-steps that feature ramping up the temperature, holding the temperature, or ramping down the temperature. An illustrative sequence of sintering sub-steps is as follows: i) ramp temperature at 5 degrees Celsius per minute to a first sintering temperature, such as 665 degrees Celsius; ii) hold at the first sintering for a first hold time, such as 2 hours; iii) ramp temperature at 1 degrees Celsius per minute to a second sintering temperature, such as 900 degrees Celsius; iv) ramp temperature at 5 degrees Celsius per minute to a third sintering temperature, such as 975 degrees Celsius; v) hold at the third sintering temperature for a second hold time, such as 5 minutes; and vi) ramp temperature at −5 degrees Celsius per minute to room temperature. This sequence of sintering sub-steps is useful for certain material combinations, such as those disclosed herein, but variations on this sintering sequence are within the scope of this disclosure.

Cathode membranes can be produced using the method disclosed herein, and the cathode porosity and density can be characterized. Cathodes produced as disclosed herein can have a porosity of no greater than 30%, no greater than 29%, no greater than 28%, no greater than 27%, no greater than 26%, no greater than 25%, no greater than 24%, no greater than 23%, no greater than 22%, no greater than 21%, no greater than 20%, no greater than 19%, no greater than 18%, no greater than 17%, no greater than 16%, no greater than 15%, no greater than 14%, no greater than 13%, no greater than 12%, no greater than 11%, no greater than 10%, no greater than 9%, no greater than 8%, no greater than 7%, no greater than 6%, no greater than 5%, no greater than 4%, no greater than 3%, no greater than 2%, or no greater than 1%. Cathodes produced as disclosed herein can have a porosity of no less than 3.5 g/cc, no less than 3.6 g/cc, no less than 3.7 g/cc, no less than 3.8 g/cc, no less than 3.9 g/cc, no less than 4.0 g/cc, no less than 4.1 g/cc, no less than 4.2 g/cc, no less than 4.3 g/cc, no less than 4.4 g/cc, no less than 4.5 g/cc, no less than 4.6 g/cc, no less than 4.7 g/cc, no less than 4.8 g/cc, no less than 4.9 g/cc, or no less than 5.0 g/cc.

In some embodiment, conductive coatings may be used on the surface of the sintered membrane to enhance electronic conductivity between the cathode and the current collector. Conductive metals, conductive carbons, conducting oxides, and conducting polymers can be used to form the conductive coatings. The coatings can be applied by conventional methods, such as solution coating, sputter coating, vapor deposition, and the like.

The following examples describe specific aspects of some embodiments of the invention to illustrate and provide a description for those of ordinary skill in the art. The examples should not be construed as limiting the invention, as the examples merely provide specific methodology useful in understanding and practicing some embodiments of the invention.

### EXAMPLES

LiF:LiBO₂ Synthesis. An NMC cathode material was milled with LiF and LiBO₂ at low energy for approximately 1 hour. In some embodiments, the NMC content of the milling vessel was at minimum 95% by weight, and in some embodiments this varied up to approximately 99% by weight. The ratio by weight of LiF to LiBO₂ ranged from 0 to 0.8. This milled powder was then mixed with benzyl butyl phthalate (BBP), polyvinyl butyral (PB), polyacrylic acid (PA), and N-Methyl-2-pyrrolidone (NMP) (used as a solvent), to form a slurry. This slurry was then tape cast onto a flat surface to form a laminate film. This film was then dried between 100 degrees Celsius and 150 degrees Celsius for 1 hour. In this embodiment, the film's final composition was 92% milled powder, 3.6% BBP, 3.6% PB, and 0.8% PA. The dried film was then cut to desired dimensions and calendared to desired thickness, which affects the final membrane porosity. Then, the film was annealed at 665 degrees Celsius for 2 hours. Further annealing occurred for intervals of time ranging from 5 minutes to 6 hours between 900 degrees Celsius and 1000 degrees Celsius. The membrane was then cooled to room temperature. During the above sintering process, BBP, PB, and PA were purged from the membrane, leaving it with the same composition as the originally milled powder.

LiF:LiBO₂ Battery Cell Formation. Battery cells were formed in a high purity argon filled glove box (M-Braun, O₂ and humidity content<0.1 ppm). The electrodes were prepared by the following method. For the cathode, the sintered membrane was dried at 150 degrees Celsius under vacuum prior to battery assembly. These cathodes were then built into a battery using an electrolyte comprising 1M LiPF₆ as the salt and a mixture of ethylene carbonate and 1,2-dimethoxyethane as the organic solvent. The EC:DME in this instance was mixed in a ratio of 3:7. A Celgard 2400 polymer separator was soaked with the above electrolyte mixture. In the tested embodiment, a lithium anode was used. A liquid electrolyte is used for testing to demonstrate that the sintered NMC electrochemical performance was not degraded by the sintering process.

LiF:LiBO₂ Testing. The battery cell was sealed and cycled galvanostatically between 2.0 V and 4.1 V at 45 degrees Celsius with rates varying from C/50 to C/10.

LiO:LiBO₂ Synthesis. An NMC cathode material was milled with Li₂O and LiBO₂ at low energy for approximately 1 hour. In some embodiments, the NMC content of the milling vessel was at minimum 97% by weight, and in some embodiments this varied up to approximately 99.9% by weight. The ratio by weight of Li₂O to LiBO₂ ranged from 0.25 to 0.75. This milled powder was then mixed with BBP, PB, PA, and NMP, to form a slurry. This slurry was then tape cast onto a flat surface to form a laminate film. This film was then dried between 100 degrees Celsius and 150 degrees Celsius for 1 hour. In this embodiment, the film's final composition was 92% milled powder, 3.6% BBP, 3.6% PB, and 0.8% PA. The dried film was then cut to desired dimensions and calendared to desired thickness, which affects the final membrane porosity. Then, the film was annealed at 665 degrees Celsius for 2 hours. Further annealing occurred for intervals of time ranging from 5 minutes to 6 hours between 900 degrees Celsius and 1000 degrees Celsius. The membrane was then cooled to room temperature. During the above sintering process, BBP, PB, and PA were purged from the membrane, leaving it with the same composition as the originally milled powder.

LiO:LiBO₂ Battery Cell Formation. Battery cells were formed in a high purity argon filled glove box (M-Braun, O₂ and humidity content<0.1 ppm). The electrodes were prepared by the following method. For the cathode, the sintered membrane was dried at 150 degrees C. under vacuum prior to battery assembly. These cathodes were then built into a battery using an electrolyte comprising 1M LiPF₆ as the salt and a mixture of ethylene carbonate and 1,2-dimethoxyethane as the organic solvent. The EC:DME in this instance was mixed in a ratio of 3:7. A Celgard 2400 polymer separator was soaked with the above electrolyte mixture. In the tested embodiment, a lithium anode was used. A liquid electrolyte is used for testing to demonstrate that the sintered NMC electrochemical performance was not degraded by the sintering process.

LiO:LiBO₂ Testing. The battery cell was sealed and cycled galvanostatically between 2.0 V and 4.1 V at 45 degrees Celsius with rates varying from C/50 to C/10.

LiF:LiBO₂+IrO₂/TiN Synthesis. An NMC cathode material was milled with LiF, LiBO₂ and either IrO₂ or TiN at low energy for approximately 1 hour. In some embodiments, the NMC content of the milling vessel was at minimum 92% by weight, and in some embodiments this varied up to approximately 97% by weight. The ratio by weight of LiF to LiBO₂ ranged from 0 to 0.8. The total content of the milled mixture by weight of IrO₂ or TiN was between 1 and 5%. This milled powder was then mixed with BBP, PB, PA, and NMP, to form a slurry. This slurry was then tape cast onto a flat surface to form a laminate film. This film was then dried between 100 degrees Celsius and 150 degrees Celsius for 1 hour. In this embodiment, the film's final composition was 92% milled powder, 3.6% BBP, 3.6% PB, and 0.8% PA. The dried film was then cut to desired dimensions and calendared to desired thickness, which affects the final membrane porosity. Then, the film was annealed at 665 degrees Celsius for 2 hours. Further annealing occurred for intervals of time ranging from 5 minutes to 6 hours between 900 degrees Celsius and 1000 degrees Celsius. The membrane was then cooled to room temperature. During the above sintering process, BBP, PB, and PA were purged from the membrane, leaving it with the same composition as the originally milled powder.

LiF:LiBO₂+IrO₂/TiN Battery Cell Formation. Battery cells were formed in a high purity argon filled glove box (M-Braun, O₂ and humidity content<0.1 ppm). The electrodes were prepared by the following method. For the cathode, the sintered membrane was dried at 150 degrees Celsius under vacuum prior to battery assembly. These cathodes were then built into a battery using an electrolyte comprising 1M LiPF₆ as the salt and a mixture of ethylene carbonate and 1,2-dimethoxyethane as the organic solvent. The EC:DME in this instance was mixed in a ratio of 3:7. A Celgard 2400 polymer separator was soaked with the above electrolyte mixture. In the tested embodiment, a lithium anode was used. A liquid electrolyte is used for testing to demonstrate that the sintered NMC electrochemical performance was not degraded by the sintering process.

Testing. The battery cell was sealed and cycled galvanostatically between 2.0 V and 4.1 V at 45 degrees Celsius with rates varying from C/50 to C/10.

LiO:LiBO₂+IrO₂/TiN Synthesis. An NMC cathode material was milled with Li₂O, LiBO₂ and either IrO₂ or TiN at low energy for approximately 1 hour. In some embodiments, the NMC content of the milling vessel was at minimum 92% by weight, and in some embodiments this varied up to approximately 97% by weight. The ratio by weight of Li₂O to LiBO₂ ranged from 0.25 to 0.75. The total content of the milled mixture by weight of IrO₂ or TiN was between 1 and 5%. This milled powder was then mixed with BBP, PB, PA, and NMP, to form a slurry. This slurry was then tape cast onto a flat surface to form a laminate film. This film was then dried between 100 degrees Celsius and 150 degrees Celsius for 1 hour. In this embodiment, the film's final composition was 92% milled powder, 3.6% BBP, 3.6% PB, and 0.8% PA. The dried film was then cut to desired dimensions and calendared to desired thickness, which affects the final membrane porosity. Then, the membrane was annealed at 665 degrees Celsius for 2 hours. Further annealing occurred for intervals of time ranging from 5 minutes to 6 hours between 900 degrees Celsius and 1000 degrees Celsius. The membrane was then cooled to room temperature. During the above sintering process, BBP, PB, and PA were purged from the membrane, leaving it with the same composition as the originally milled powder.

LiO:LiBO₂+IrO₂/TiN Battery Cell Formation. Battery cells were formed in a high purity argon filled glove box (M-Braun, O₂ and humidity content<0.1 ppm). The electrodes were prepared by the following method. For the cathode, the sintered membrane was dried at 150 degrees Celsius under vacuum prior to battery assembly. These cathodes were then built into a battery using an electrolyte comprising 1M LiPF₆ as the salt and a mixture of ethylene carbonate and 1,2-dimethoxyethane as the organic solvent. The EC:DME in this instance was mixed in a ratio of 3:7. A Celgard 2400 polymer separator was soaked with the above electrolyte mixture. In the tested embodiment, a lithium anode was used. A liquid electrolyte is used for testing to demonstrate that the sintered NMC electrochemical performance was not degraded by the sintering process.

LiO:LiBO₂+IrO₂/TiN Testing. The battery cell was sealed and cycled galvanostatically between 2.0 V and 4.1 V at 45 degrees Celsius with rates varying from C/50 to C/10.

LiO:LiBO₂ Synthesis (Gold Coated). An NMC cathode material was milled with Li₂O and LiBO₂ at low energy for approximately 1 hour. In some embodiments, the NMC content of the milling vessel was at minimum 97% by weight, and in some embodiments this varied up to approximately 99.9% by weight. The ratio by weight of Li₂O to LiBO₂ ranged from 0.25 to 0.75. This milled powder was then mixed with BBP, PB, PA, and NMP, to form a slurry. This slurry was then tape cast onto a flat surface to form a laminate film. In this embodiment, the film's final composition was 92% milled powder, 3.6% BBP, 3.6% PB, and 0.8% PA. This film was then dried between 100 degrees Celsius and 150 degrees Celsius for 1 hour. The dried film was then cut to desired dimensions and annealed at 665 degrees Celsius for 2 hours. Further annealing occurred for intervals of time ranging from 5 minutes to 6 hours between 900 degrees Celsius and 1000 degrees Celsius. The membrane was then cooled to room temperature. During the above sintering process, BBP, PB, and PA were purged from the membrane, leaving it with the same composition as the originally milled powder.

Gold Conductive Coating. The sintered membrane was placed into a Cressington sputter coater under vacuum for 2 hours. Prior to sputtering an argon flow rate was set to 9 mL/min and then gold was sputtered on the pellet using five intervals of 60 second sputters.

LiO:LiBO₂ Solid-State Battery Cell Formation. Battery cells were formed in a high purity argon filled glove box (M-Braun, O₂ and humidity content<0.1 ppm). The electrodes were prepared by the following method. For the cathode, the coated sintered membrane was dried at 150 degrees Celsius under vacuum prior to battery assembly. These cathodes were then built into a battery using a solid polymer electrolyte that functioned as both the electrolyte and separator. In the tested embodiment, a lithium anode was used.

LiO:LiBO₂ Solid-State Battery Testing. The battery cell was sealed and cycled galvanostatically between 2.0 V and 4.1 V at 45 degrees Celsius with rates varying from C/50 to C/10.

LiO:LiBO₂ Synthesis (Carbon Coated). An NMC cathode material was milled with Li₂O and LiBO₂ at low energy for approximately 1 hour. In some embodiments, the NMC content of the milling vessel was at minimum 97% by weight, and in some embodiments this varied up to approximately 99.9% by weight. The ratio by weight of Li₂O to LiBO₂ ranged from 0.25 to 0.75. This milled powder was then mixed with BBP, PB, PA, and NMP, to form a slurry. This slurry was then tape cast onto a flat surface to form a laminate film. In this embodiment, the film's final composition was 92% milled powder, 3.6% BBP, 3.6% PB, and 0.8% PA. This film was then dried between 100 degrees Celsius and 150 degrees Celsius for 1 hour. The dried film was then cut to desired dimensions and annealed at 665 degrees Celsius for 2 hours. Further annealing occurred for intervals of time ranging from 5 minutes to 6 hours between 900 degrees Celsius and 1000 degrees Celsius. The membrane was then cooled to room temperature. During the above sintering process, BBP, PB, and PA were purged from the membrane, leaving it with the same composition as the originally milled powder.

Carbon Conductive Coating. 200 mg of double-walled carbon nanotubes (CNT's) were added to 15 mL NMP and mixed using a Thinky mixer for 5 minutes. After mixing 50 uL of the dispersed CNT's were pipetted onto the sintered cathode membrane such that an even dispersion was achieved. The membrane was then dried at 150 degrees Celsius for 1 hour.

LiO:LiBO₂ Solid-State Battery Cell Formation. Battery cells were formed in a high purity argon filled glove box (M-Braun, O₂ and humidity content<0.1 ppm). The electrodes were prepared by the following method. For the cathode, the coated sintered membrane was dried at 150 degrees Celsius under vacuum prior to battery assembly. These cathodes were then built into a battery using a solid polymer electrolyte that functioned as both the electrolyte and separator. In the tested embodiment, a lithium anode was used.

LiO:LiBO₂ Solid-State Battery Testing. The battery cell was sealed and cycled galvanostatically between 2.0 V and 4.1 V at 45 degrees Celsius with rates varying from C/50 to C/10.

### Results

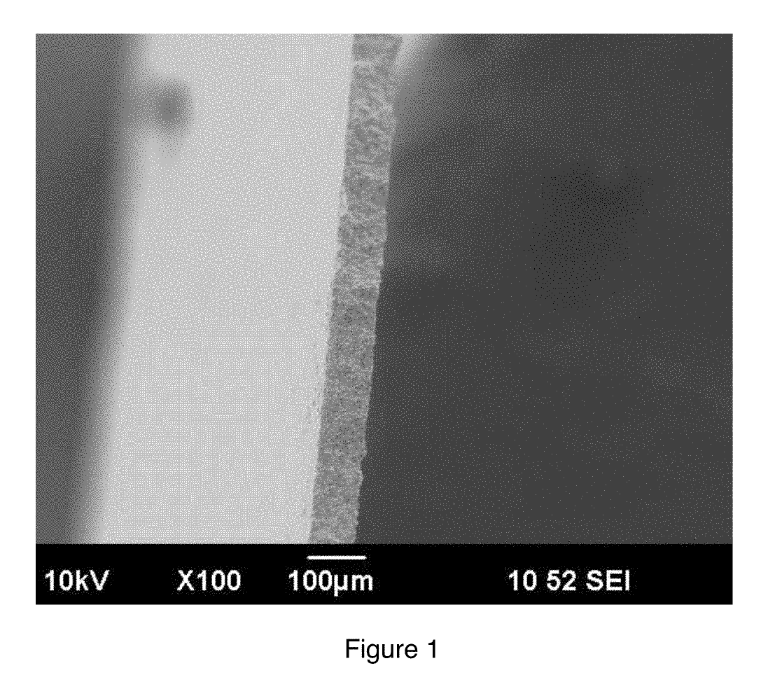

FIG. 1 is a scanning electron micrograph of a sintered cathode that uses a composition of LiF:LiBO₂ as an ion conducting sintering aid. The cathode membrane appears to be fairly uniformly dense and does not have significant porosity. Is it particularly noteworthy that the sintered cathode in FIG. 1 consists of fused particles. As discussed above, layered oxides typically lose electrochemical activity when treated at temperatures sufficient to produce fused particles. As seen in the testing below, these sintered cathode unexpectedly retain electrochemical activity despite the high temperature treatment.

In FIG. 1, The porosity is calculated by theoretical volume of the membrane divided by the actual volume. The actual volume is obtained by measuring the thickness and area of the membrane. The theoretical volume is calculated by the membrane mass and the theoretical density which depends on the composition and the theoretical density of each component.

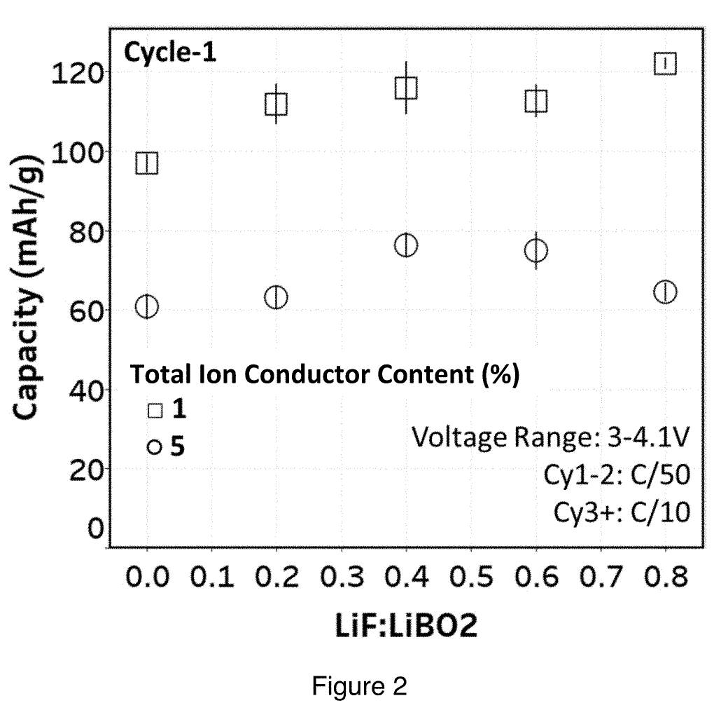

FIG. 2 is an illustration of the first cycle capacity for a sintered NMC electrode cycled in a voltage range from 3 to 4.1 volts. Two distinct weight percentages of ion conducting material were tested, 1% and 5%, and for each of these, five distinct ratios of LiF to LiBO₂ were tested (0.0, 0.2, 0.4, 0.6, and 0.8). Vertical lines show the standard deviation for replicated cells. As the figure generally illustrates, greater capacities were achieved by the group with 1% ion conducting content. This is likely due at least in part to the increase in total amount of cathode active material with a lower ion conducting material content within the cathode.

FIG. 2 further illustrates that the first cycle capacity is greatest for both groups with a LiF:LiBO₂ ratio of 0.4, with the exception of the ratio 0.8, which showed a decrease in performance for the 5% ion conducting content group, but an increase in performance for the 1% ion conducting content group (with the smallest standard deviation between trials of any of the embodiments shown in this figure).

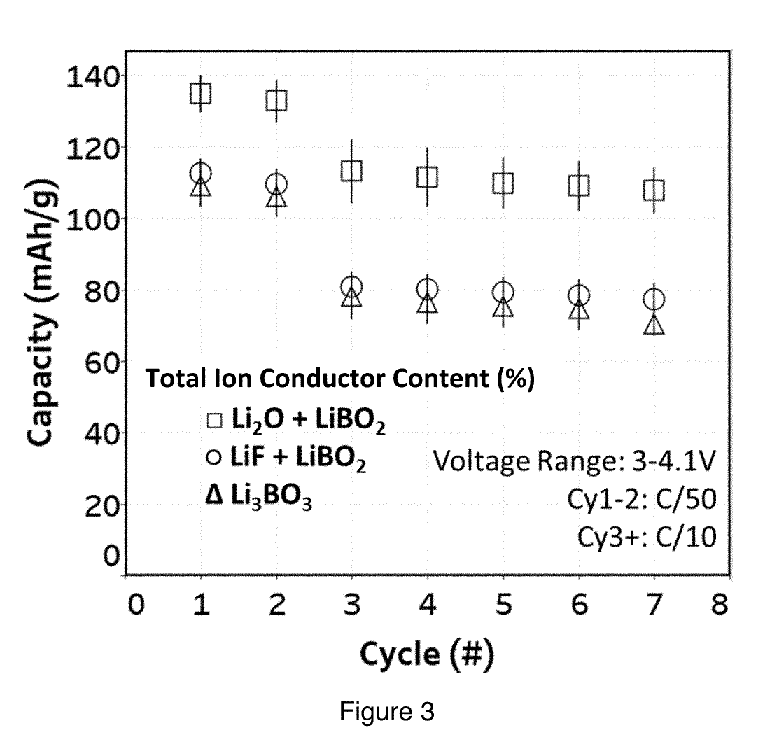

FIG. 3 illustrates the capacity versus cycle number for sintered NMC cathodes cycled between 3 and 4.1 volts, having Li₂O+LiBO₂, LiF+LiBO₂, and Li₃BO₃ ion conducting components. The first two cycles were performed at a discharge rate of C/50 and cycles from the third cycle onward were performed at a discharge rate C/10. FIG. 3 further illustrates similar performance for LiF+LiBO₂ and Li₃BO₃ embodiments. The Li₂O+LiBO₂ embodiments tested herein exhibited greater capacity across all tested cycle numbers, on the order of 20 mAh/g. Across all embodiments, capacity per unit mass decreased slightly with each cycle on average.

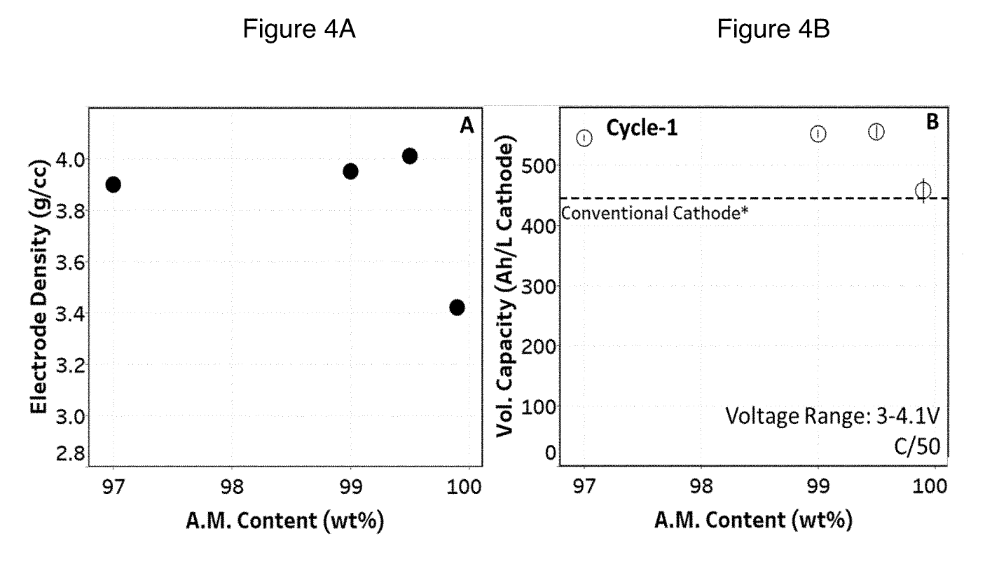

FIGS. 4A and 4B illustrate the electrode densities and volumetric capacities of electrodes having active cathode material (in this case NMC) at various weight percentages. FIG. 4A illustrates the electrode density in grams per cubic centimeter of a sintered NMC cathode having various weight percentages of a Li₂O:LiBO₂ ion conducting sintering aid. FIG. 4B illustrates the first cycle volumetric capacity for the same discrete weight percentages of Li₂O:LiBO₂ ion conducting sintering aid in a sintered NMC cathode. This chart further provides a dashed line representing a conventional cathode, wherein this cathode is 92% active material, 29% porosity, and has a gravimetric capacity of 160 mAh/g. As can been seen in FIG. 4B, the volumetric capacity of all tested contents had a better average performance than the conventional cathode.

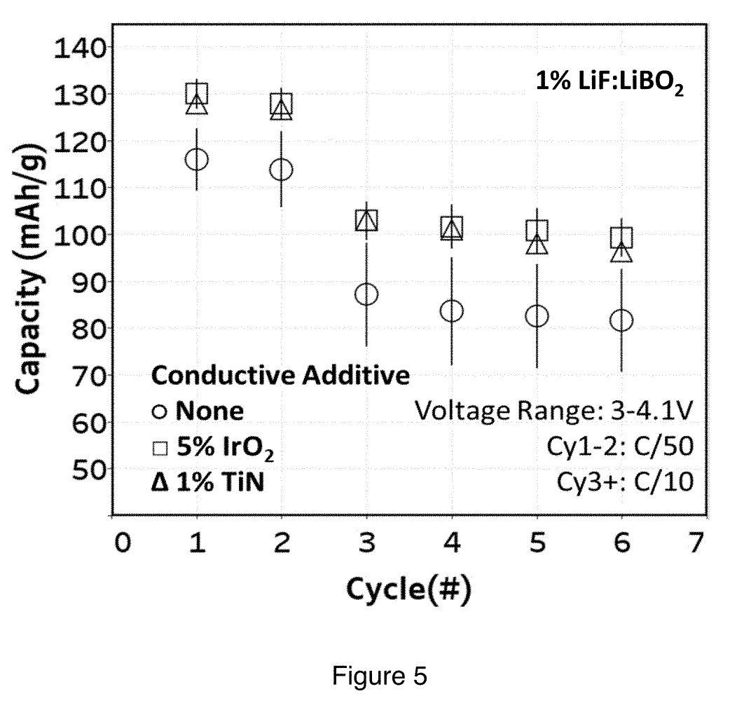

FIG. 5 illustrates the capacity in mAh/g of a sintered NMC cathode versus the cycle number for up to 7 cycles. Similar to the above, the first two cycles were conducted at a rate of C/50, and cycles from the third cycle onward were conducted at C/10. Cycles were performed at a potential range from 3 to 4.1 volts. The sintered cathode formulation contained a 1% by weight sintering aid of LiF:LiBO₂. In two of the tested embodiments shown in this image, other additives were used. In one embodiment, 5% by weight IrO₂ was added to the cathode, and in another embodiment, 1% by weight TiN was added to the cathode. As the image shows, embodiments having the additional additives had greater gravimetric capacities across all cycles than embodiments having only LiF:LiBO₂.

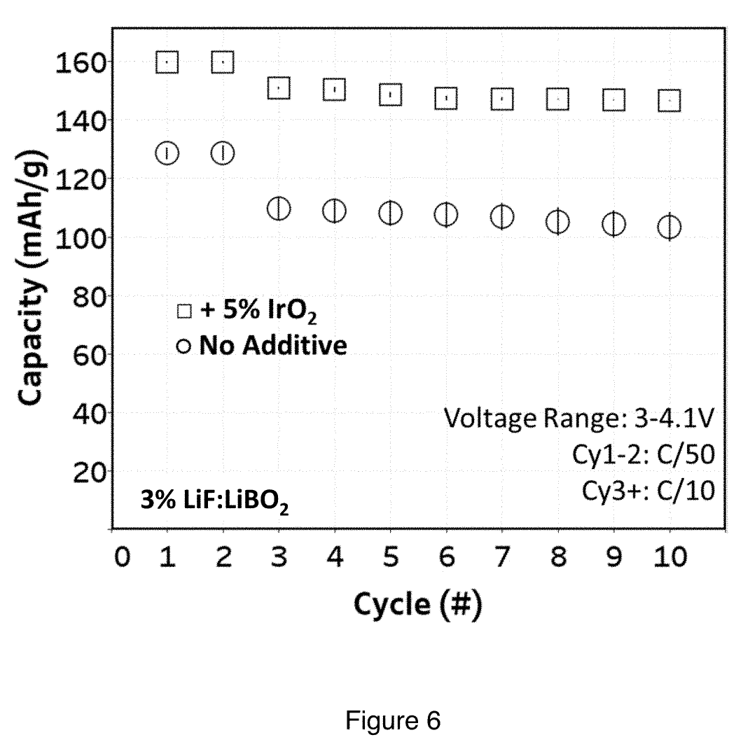

FIG. 6 illustrates a comparison of gravimetric capacity versus cycle number for a sintered NMC cathode having 3% by weight Li₂O:LiBO₂ as an ion conducting sintering aid. In one of the shown embodiments, there are no additional additives. In another shown embodiment, there is an additional additive of 5% by weight IrO₂. Ten cycles are shown on this chart, conducted between 3 and 4.1 volts, and with the first two cycles performed at a rate of C/50. From the third cycle onward, the rate was C/10. As sown in this image, the addition of a 5% by weight additive of IrO₂ improved the capacity of the cathode by at least 20 mAh/g across all cycles. Additionally, the data would suggest the average measured capacity per cycle number of each tested embodiment decreases slightly with each cycle, but that this effect is less pronounced for embodiments having the additional 5% IrO₂.

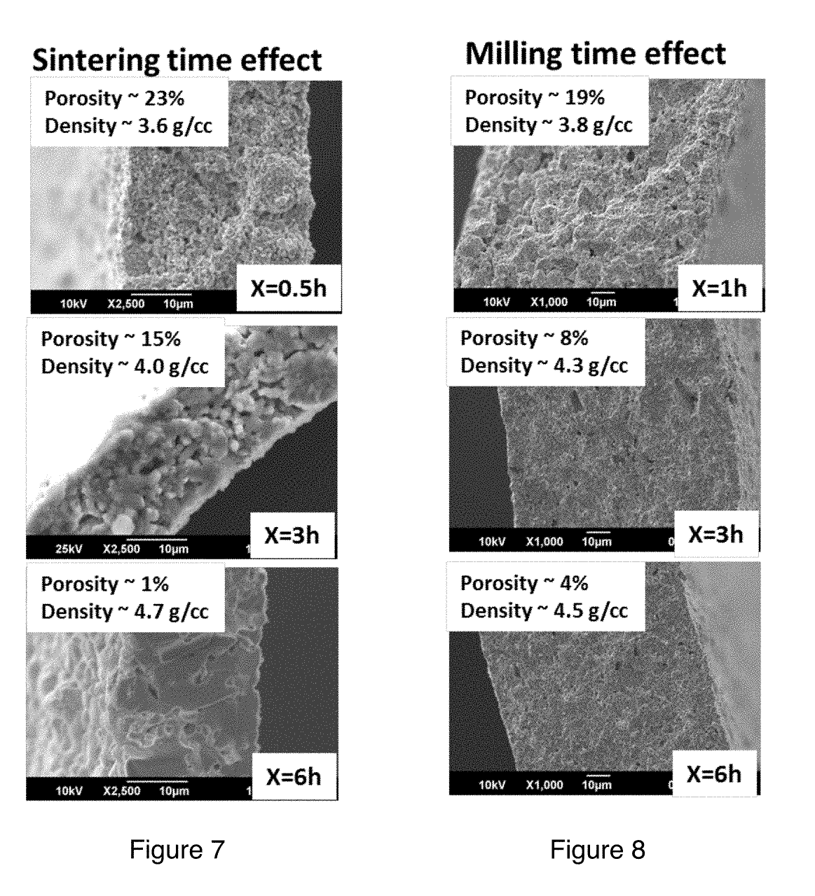

FIG. 7 shows three scanning electron micrographs of sintered electrodes in which the sintering time has been a varied. The variations in sintering time produce variations in the porosity and density of the sintered active material. Specifically, at a sintering time of 0.5 hours, the porosity of the sintered cathode material was approximately 23% and the density was approximately 3.6 grams per cubic centimeter. At a sintering time of 3 hours, the porosity of the sintered cathode material was approximately 15% and the density was approximately 4.0 grams per cubic centimeter. At a sintering time of 6 hours, the porosity of the sintered cathode material was approximately 1% and the density was approximately 4.7 grams per cubic centimeter. In this study, milling time was held constant. Thus, there is an inverse relationship between porosity and sintering time and a direct relationship between density and sintering time. Again, it is noteworthy that the cathode depicted in these micrographs consists of sintered particles of an electrochemically active layered oxide. Typically, a layered oxide would lose electrochemical activity when treated at these high temperatures.

FIG. 8 shows three scanning electron micrographs of centered electrodes in which the milling time has been varied. The variations in milling time produce variations in the porosity and density of the sintered active material. Specifically, at a milling time of 0.5 hours, the porosity of the sintered cathode material was approximately 19% and the density was approximately 3.8 grams per cubic centimeter. At a milling time of 3 hours, the porosity of the sintered cathode material was approximately 8% and the density was approximately 4.3 grams per cubic centimeter. At a milling time of 6 hours, the porosity of the sintered cathode material was approximately 4% and the density was approximately 4.5 grams per cubic centimeter. In this study, sintering time was held constant. Thus, there is an inverse relationship between porosity and milling time and a direct relationship between density and milling time. Again, it is noteworthy that the cathode depicted in these micrographs consists of sintered particles of an electrochemically active layered oxide. Typically, a layered oxide would lose electrochemical activity when treated at these high temperatures.

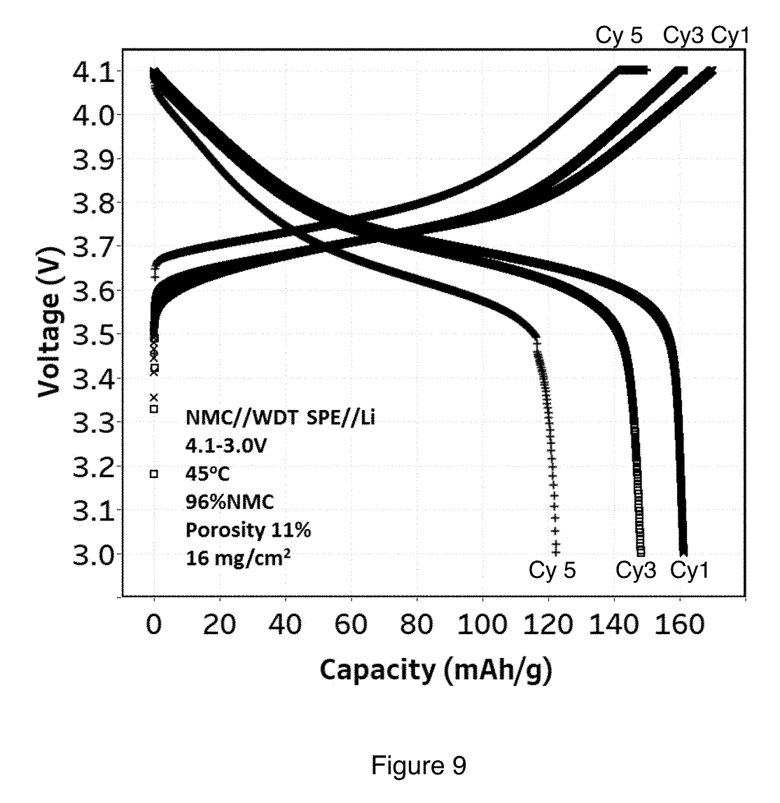

FIG. 9 illustrates the results of electrochemical testing of a sintered NMC cathode in a solid state battery, showing the voltage versus capacity performance at cycle one, cycle three, and cycle five. In this case, a solid-state electrolyte was used. The cycling rates were C/50 for cycle 1 and cycle 2 (not pictured); C/10 for cycle 3 and cycle 4 (not pictured); C/3 for cycle 5. The porosity of the tested cathode was approximately 11%. This testing took place at an elevated temperature of 45 degrees Celsius and shows desirable performance of the sintered cathode in the absence of a liquid electrolyte.

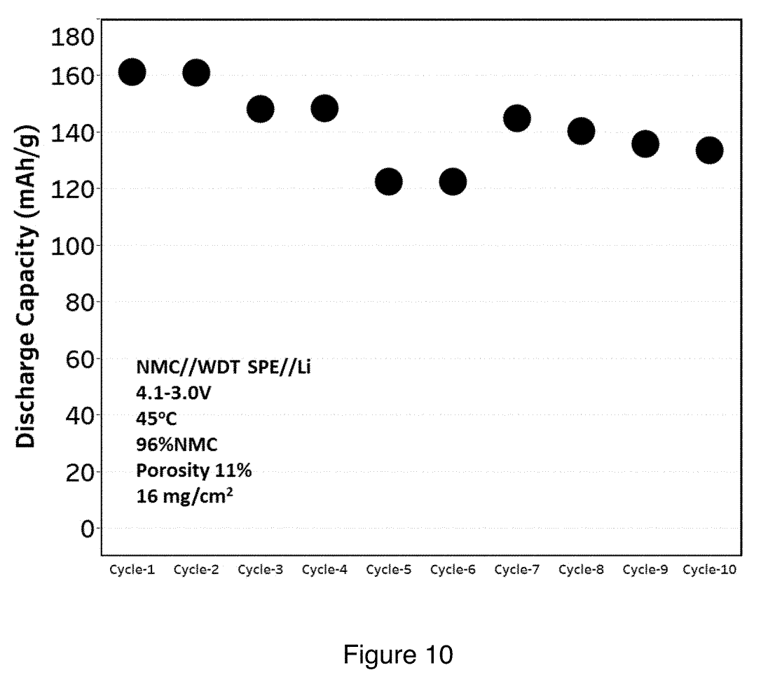

FIG. 10 illustrates the results of tests of the discharge capacity at various cycle numbers for a sintered NMC cathode in an solid state battery, showing discharge capacity as a function of cycle number. In this case, a solid-state electrolyte was used. The cycling rates were C/50 for cycle 1 and cycle 2; C/10 for cycle 3 and cycle 4; C/3 for cycle 5 and cycle 6; and C/10 for cycles 7-10. The porosity of the tested cathode was approximately 11%. This testing took place at an elevated temperature of 45 degrees Celsius and shows desirable performance of the sintered cathode in the absence of a liquid electrolyte.

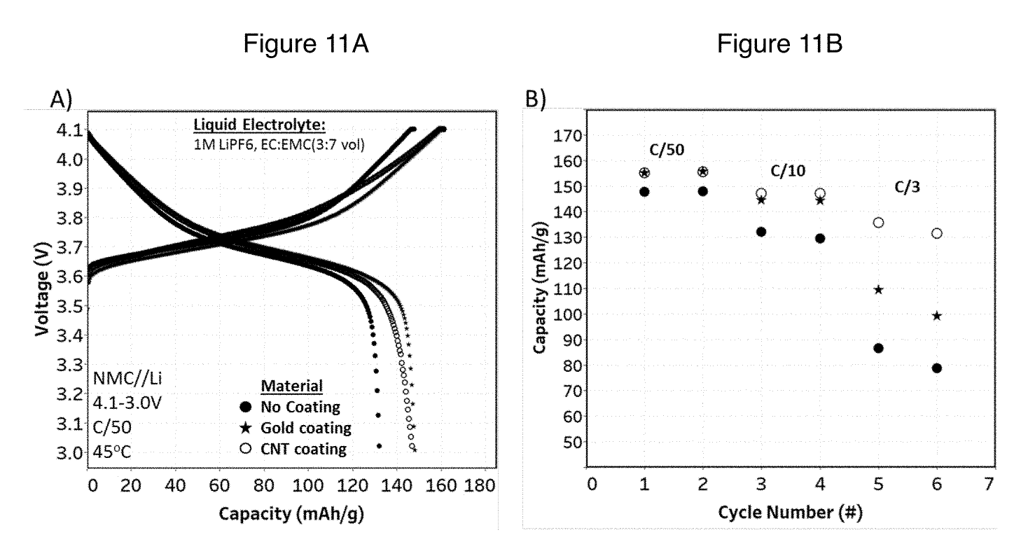

FIG. 11 illustrates the tests of the sintered NMC cathodes with and without conductive coatings. FIG. 11A shows the voltage versus capacity curves at C/50 for the first cycle for sintered cathodes in cells where the sintered membrane had no coating, a conductive gold coating, or a conductive carbon (CNT) coating. Total capacities of approximately 150 mAh/g are achieved for the cells containing sintered cathodes that have conductive coatings compared to approximately 130 mAh/g for the uncoated cathodes. FIG. 11B shows the capacities obtained at higher c-rates for the coated and uncoated cathodes. At C/3, the CNT coated cathode yields approximately 135 mAh/g capacity compared to approximately 80 mAh/g for the uncoated cathode membrane. At C/3, the gold coated cathode yields approximately 100 mAh/g compared to approximately 80 mAh/g for the uncoated cathode membrane.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

1. A cathode comprising:
a membrane comprising fused particles of an electrochemically active material and a sintering product, wherein the particles of the electrochemically active material are fused via the sintering product;
wherein the membrane is characterized by a porosity of no greater than 30% and the electrochemically active material comprises at least about 92% of the total weight of the membrane.

2. The cathode of claim 1 wherein the electrochemically active material comprises a layered oxide.

3. The cathode of claim 1 wherein the electrochemically active material comprises LiNiₓMn_{y}Co_{z}O_{w}, where 0≤x<1; 0≤y<1; 0≤z≤1; and 1.8≤w≤2.2.

4. (canceled)

5. The cathode of claim 1 wherein the sintering product comprises unreacted sintering aid, reacted sintering aid, decomposed sintering aid, and combinations thereof.

6. The cathode of claim 5 wherein the sintering aid is selected from the group consisting of Li₃BO₃, Li₂O, LiF, LiBO₂ and combinations thereof.

7. The cathode of claim 5 wherein the sintering aid comprises a combination of Li₂O and LiBO₂.

8. The cathode of claim 5 wherein the sintering aid comprises a combination of LiF and LiBO₂.

9. The cathode of claim 1 further comprising an electron-conducting additive.

10. The cathode of claim 9 wherein the electron-conducting additive is selected from the group consisting of IrO₂, ReO₂, and TiN.

11. The cathode of claim 1 further comprising a conductive coating deposited on a surface of the membrane.

12. The cathode of claim 11 wherein the conductive coating comprises gold or conductive carbon.

13. The cathode of claim 1 wherein the membrane is characterized by a porosity of no greater than 15%.

14. The cathode of claim 1 wherein the membrane is characterized by a porosity of no greater than 10%.

15. The cathode of claim 1 wherein the membrane is characterized by a porosity of no greater than 5%.

16. The cathode of claim 1 wherein the membrane is characterized by a porosity of no greater than 1%.

17. A method for forming a cathode membrane, comprising:
preparing a solution comprising a binder and a solvent;
milling an electrochemically active material and a sintering aid to form a milled material;
mixing the solution and the milled material to form a mixture;
casting the mixture to form a film of a desired thickness; and
sintering the film to form the cathode membrane wherein the cathode membrane comprises fused particles of electrochemically active material and the membrane is characterized by a porosity of no greater than about 15%.

18. The method of claim 17 further comprising milling an inorganic electron-conducting additive with the electrochemically active material and the sintering aid.

19. The method of claim 17 further comprising forming a conductive coating on a surface of the cathode membrane.

20. The method of claim 17 wherein the electrochemically active material comprises a layered oxide.

21. (canceled)

22. The method of claim 17 wherein the sintering aid is selected from the group consisting of Li₃BO₃, Li₂O, LiF, LiBO₂ and combinations thereof.
